(19) United States
(12) Patent Application Publication
(10) Pub. No.: US 2017/0247567 A1
(43) Pub. Date: Aug. 31, 2017

(54) COMPOSITION

(71) Applicant: JOTUN A/S, Sandefjord (NO)

(72) Inventors: Morten HØIÅS, Sandefjord (NO); Benedicte Riise SØRENSEN, Porsgrunn (NO)

(21) Appl. No.: 15/512,662

(22) PCT Filed: Sep. 18, 2015
(86) PCT No.: PCT/EP2015/071473

§ 371 Date: Mar. 20, 2017

(30) Foreign Application Priority Data
Sep. 19, 2014 (EP) 14185670.8

(51) Int. Cl. C09D 175/06; F03D 1/06; C08G 18/79; C08G 18/40; C08G 18/44

(52) U.S. Cl. CPC C09D 175/06; C08G 18/4063; C08G 18/4018; C08G 18/44; C08G 18/792; F03D 1/0675; F05B 2230/90; F05B 2280/4003; F05B 2280/4011

(57) ABSTRACT

The invention relates to a substrate coated with a coating composition, wherein the coating composition has a volume solids content of greater than 30%, said composition comprising (i) at least one polycarbonate polyol; (ii) at least one hydroxyl containing polymer selected from the group consisting of an acrylic polyol, a polyester polyol and a mixture thereof; and (iii) at least one polyisocyanate curing agent; wherein the weight ratio of (i):(ii) is 9:1 to 1:9 and wherein, if present, said polyester polyol is different to said polycarbonate polyol; and wherein the substrate is selected from the group consisting of aircraft wings, wind turbine blades, rotor blades, propellers, randomes, antenaae, fan blade nose cones and high speed vehicles.

### FIELD OF THE INVENTION

This invention relates to coating compositions, in particular to a coating composition for wind turbine blades. The invention further relates to substrates and articles coated with the coating composition and to the use of the coating composition in coating articles such as wind turbine blades.

### BACKGROUND

A common challenge for the wind turbine industry is the wear and erosion of the wind turbine blades due to the high velocity at the tip of the blade combined with the collision of rain droplets and particulate material, such as dust or sand. In addition, sunlight causes UV degradation over time.

Previous attempts to prolong the lifetime of the blades have included the use of anti-erosive tape. However, more recently, painting the blades with a protective coating has been employed. Polyurethane coatings represent those most commonly used to date.

WO 2010/122157 discloses a polyurethane-based coating prepared from a base component and a curing agent, wherein the base component consists of one or more polyols with at least 50 wt % aliphatic polyols. Other examples are disclosed in CN 102031059, CN 102153943 and CN 101805549. Polyurethanes are also known as coatings for substrates other than wind turbine blades, as described in e.g. US 2010/0124649 and WO 2011/027640

Coatings for wind turbine blades require a particular combination of properties which enables them to withstand wear, erosion and UV degradation. Elastic, tough and UV resistant coatings are desired. The present inventors have surprisingly found that the coating compositions of the present invention, which combine specifically an hydroxyl containing polymer, a polycarbonate and a polyisocyanate possess the necessary balance of properties.

It is thus an object of the present invention to provide an improved coating composition which possesses both good erosion resistance and elasticity. In particular, a coating which is more durable than those of the prior art is desired. A coating which is fast drying is looked-for. Preferably, improvement is observed in more than one of these factors.

### SUMMARY

Thus, in a first aspect, the invention provides a substrate coated with a coating composition, wherein the coating composition has a volume solids content of greater than 30%, said composition comprising:

(i) at least one polycarbonate polyol;

(ii) at least one hydroxyl containing polymer selected from the group consisting of an acrylic polyol, a polyester polyol and a mixture thereof; and

(iii) at least one polyisocyanate curing agent;

wherein the weight ratio of (i):(ii) is 9:1 to 1:9 and wherein, if present, said polyester polyol is different to said polycarbonate polyol; and

wherein the substrate is selected from the group consisting of aircraft wings, wind turbine blades, rotor blades, propellers, randomes, antenaae, fan blade nose cones and high speed vehicles.

In another aspect, the invention provides for the use of a coating composition as hereinbefore described for coating a substrate as hereinbefore defined.

In a further aspect, the invention provides a process for coating a substrate comprising coating a substrate as defined herein with a composition as hereinbefore described.

The invention also provides a coating composition with a volume solids content of greater than 60%, said composition comprising:
(i) at least one polycarbonate polyol;
(ii) at least one hydroxyl containing polymer selected from the group consisting of an acrylic polyol, a polyester polyol and a mixture thereof; and
(iii) at least one polyisocyanate curing agent;
   wherein the weight ratio of (i):(ii) is 9:1 to 1:9 and wherein, if present, said polyester polyol is different to said polycarbonate polyol.

In another aspect, the invention provides a kit for use in the manufacture of a coating composition as hereinbefore described, said kit comprising:

a) at least one polycarbonate polyol and at least one hydroxyl containing polymer selected from the group consisting of an acrylic polyol, a polyester polyol and a mixture thereof in a first part; and

b) at least one polyisocyanate curing agent in a second part.

### DETAILED DESCRIPTION

This invention relates to a coating composition which can be used to coat a substrate, in particular wind turbine blades. The coating composition contains at least three components: at least one polycarbonate polyol (i), at least one hydroxyl containing polymer (ii) selected from the group consisting of an acrylic polyol, a polyester polyol and a mixture thereof, and at least one polyisocyanate (iii).

### Polycarbonate

The coating compositions of the invention comprise at least one polycarbonate polyol. The polycarbonate may be any curable or crosslinkable polycarbonate or a mixture of curable or crosslinkable polycarbonates. By “curable” or “crosslinkable” it is meant that the polycarbonate contains reactive groups, e.g. OH groups, which enable it to be cured or crosslinked.

By “polycarbonate polyol” we mean any polycarbonate polymer which contains two or more hydroxyl (OH) moieties. In all embodiments of the invention, it is preferable if the polycarbonate polyol is a diol, i.e. contains two hydroxyl functional groups. More preferably, the two hydroxyl functional groups are terminal groups on the polymer chain, i.e. one at each end of the polymer chain.

Preferably, the polycarbonate polyol comprises a repeating unit with the following structure:

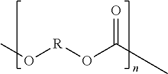

wherein
R is selected from the group consisting of linear or branched C₁₋₂₀ alkyl groups, C₃₋₁₂ cycloalkyl groups, and optionally substituted C₆₋₂₀ aryl groups; and
n is an integer from 2 to 50.

Preferably, R is a linear or branched C₁₋₂₀ alkyl group. The term “alkyl” is intended to cover linear or branched alkyl groups such as propyl, butyl, pentyl and hexyl. It will be understood that the “alkyl” group in the context of the polycarbonate is divalent and thus may also be referred to as “alkylene”. Particularly preferable alkyl groups are pentyl and hexyl. In one particularly preferred embodiment, R is hexyl. In all embodiments, the alkyl group is preferably linear.

In one embodiment, only a single (i.e. one type of) repeating unit is present. In an alternative embodiment, more than one, e.g. two, different repeating units are present. If different repeating units are present they may have a random or a regular distribution within the polycarbonate polyol. It will be understood that where more than one repeating unit is present, these repeating units will contain different R groups. In one preferable embodiment, two repeating units are present, in the first R is pentyl and in the second R is hexyl.

Particularly preferred cycloalkyl groups include cyclopentyl and cyclohexyl.

Examples of the substituted aryl groups include aryl groups substituted with at least one substituent selected from halogens, alkyl groups having 1 to 8 carbon atoms, acyl groups, or a nitro group. Particularly preferred aryl groups include substituted and unsubstituted phenyl, benzyl, phenylalkyl or naphthyl.

It is preferable if R does not contain an hydroxyl functional group.

Preferably, n is an integer in the range 2 to 25, such as 2 to 20, e.g. 2 to 15.

The at least one polycarbonate polyol is preferably present in the coating composition of the invention in a range of 5 to 25 wt %, such as 8 to 20 wt %, e.g. 10 to 15 wt %. It will be appreciated that where more than one polycarbonate polyol is present in the coating compositions, the hereinbefore quoted wt % ranges relate to the total amount of all polycarbonate polyols employed.

The number average molecular weight (Mn) of the polycarbonate is preferably between 200 and 20,000, more preferably 500 to 10,000, such as less than 5000, e.g. 1000 (determined by GPC).

The functionality of the polycarbonate polymer (i.e. the number of hydroxyl groups present per molecule) may range from 2 to 10. Preferably, the functionality is 2.

The polycarbonate polyols of the invention preferably have a hydroxyl number of 50-250, such as 60-120 mg KOH/g.

The viscosity at 40° C. of the polycarbonate polyol may range from 10 mPa·s to 10,000 mPa·s (10 to 10,000 cP), such as 50 mPa·s to 5,000 mPa·s (50 to 5,000 cP), especially 300 mPa·s to 4,000 mPa·s (300 to 4000 cP).

It is, of course, possible to employ a mixture of two or more polycarbonate polyols in the compositions of the invention, however it is preferable if only a single polycarbonate polyol is used.

Preferably, the polycarbonate polyol is amorphous.

The glass transition temperature (Tg) of the polycarbonate polyol is preferably below 0° C.

Polycarbonates for use in the invention can be purchased commercially. Commercial suppliers include Bayer, UBE and Asahi Kasei and suitable polycarbonates (i) are sold under trade names such as Duranol, Eternacoll and Desmophen. Particular examples of suitable commercially available polycarbonates are Duranol T5651, Desmophen C1100, Demophen C XP 2716, Eternacoll PH-100 and Eternacoll PH-50.

### Hydroxyl Containing Polymer

The coating compositions of the invention also comprise at least one hydroxyl containing polymer (ii) which may be selected from the group consisting of an acrylic polyol, a polyester polyol or a mixture thereof. It is possible to employ a mixture of two or more hydroxyl containing polymers in the compositions of the invention, and in such circumstances it is possible to use a mixture consisting of only acrylic polyols, a mixture consisting of only polyester polyols or a mixture containing both acrylic polyols and polyester polyols. However, it is preferable if only a single hydroxyl containing polymer is used, most preferably this is an acrylic polyol.

By “acrylic polyol” we mean any polyol which is prepared from two or more acrylate monomers. Moreover, the “acrylic polyol” contains at least two hydroxyl (OH) functional groups.

The acrylic polyol is not particularly restricted but may be any acrylic polyol having reactivity with a polyisocyanate and examples thereof may include compounds obtained by polymerization of a mixture of unsaturated monomers selected from unsaturated monomers containing a hydroxyl group, unsaturated monomers containing an acid group, and other unsaturated monomers.

The above-mentioned unsaturated monomers containing a hydroxyl group is not particularly restricted and examples thereof may include hydroxyethyl acrylate, hydroxyethyl methacrylate, hydroxypropyl methacrylate, hydroxybutyl acrylate, Placcel FM-1 (manufactured by Daicel Chemical Industries; ε-caprolactone-modified hydroxyethyl methacrylate), polyethylene glycol monoacrylate or monomethacrylate, and polypropylene glycol monoacrylate or monomethacrylate.

The above-mentioned unsaturated monomer containing an acid group is not particularly restricted and examples thereof may include carboxylic acids such as acrylic acid, methacrylic acid, itaconic acid, crotonic acid, and maleic acid.

The above-mentioned other unsaturated monomers are not particularly restricted and examples thereof may include acrylic monomers containing an ester group such as methyl acrylate, ethyl acrylate, propyl acrylate, butyl acrylate, hexyl acrylate, ethylhexyl acrylate, or lauryl acrylate or methacrylate esters; vinylalcohol ester type monomers such as esters of carboxylic acids, e. g. acetic acid and propionic acid with vinyl alcohol; unsaturated hydrocarbon monomers such as styrene, a-methylstyrene, vinylnaphthalene, butadiene, and isoprene; nitrile type monomers such as acrylonitrile and methacrylonitrile; and acrylamide type monomers such as acrylamide, methacrylamide, N-methylolacrylamide, N,N-dimethylacrylamide, and diacetoneacrylamide.

In one embodiment, the acrylic polyol is one comprising the following repeating unit:

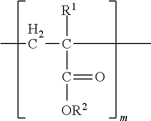

wherein R¹ and R² may be the same or different, preferably different, and are each independently selected from the group consisting of hydrogen, linear or branched C₁₋₂₀ alkyl groups, linear or branched hydroxyC₁₋₂₀alkyl groups, C₃₋₁₂ cycloalkyl groups, and optionally substituted C₆₋₂₀ aryl groups; and
m is an integer from 2 to 50.

Preferably, R¹ and R² are each independently hydrogen, a linear or branched C₁₋₂₀ alkyl group or a linear or branched hydroxyC₁₋₂₀alkyl. The term “alkyl” is intended to cover linear or branched alkyl groups such as methyl, ethyl, propyl, butyl, pentyl and hexyl. Particularly preferable alkyl groups are methyl, pentyl and hexyl. In all embodiments, the alkyl group is preferably linear.

Preferably, R¹ is hydrogen or C₁₋₆alkyl, e.g. methyl.

Preferably, R¹ is hydrogen, C₁₋₆alkyl or hydroxyC₁₋₆alkyl.

Particularly preferred cycloalkyl groups include cyclopentyl and cyclohexyl.

Examples of the substituted aryl groups include aryl groups substituted with at least one substituent selected from halogens, alkyl groups having 1 to 8 carbon atoms, acyl groups, or a nitro group. Particularly preferred aryl groups include substituted and unsubstituted phenyl, benzyl, phenalkyl or naphthyl.

Preferably, m is an integer in the range 2 to 25, such as 2 to 20, e.g. 2 to 15.

In one embodiment, only a single (i.e. one type of) repeating unit is present. In an alternative embodiment, more than one, e.g. two, different repeating units are present. If different repeating units are present they may have a random or a regular distribution within the acrylic polyol. It will be understood that where more than one repeating unit is present, these repeating units will differ in at least one of R¹ and R².

The number average molecular weight (Mn) of the acrylic polyol is preferably between 200 and 20,000 (determined by GPC).

The functionality of the acrylic polyol (i.e. the number of hydroxyl groups present per molecule) may range from 2 to 10. The acrylic polyols of the invention preferably have a hydroxyl number of 50-250 mg KOH/g, such as 75-180 mg KOH/g calculated on non-volatiles.

The viscosity at 23° C. of the acrylic polyol may range from 10 mPa·s to 20,000 mPa·s (10 to 20,000 cP), such as 100 mPa·s to 15,000 mPa·s (100 to 15,000 cP), especially 500 mPa·s to 12,000 mPa·s (500 to 12000 cP). The viscosity may be measured on the pure acrylic polyol or the acrylic polyol in solution. Preferably, the viscosity is measured for the acrylic polyol in butyl acetate, such as a 50-100 wt % of the acrylic polyol in butyl acetate, e.g. 75 wt % in butyl acetate.

Acrylic polyols for use in the invention can be purchased commercially. Commercial suppliers include Cytec, DSM, Nuplex and Cray Valley and suitable acrylic polyols are sold under trade names such as Macrynol, Setalux, Synocure and Uracron. Particular examples of suitable commercially available acrylic polyols are Macrynal SM 2810/75BAC, Setalux 1914, Setalux 1907, Setalux 1909, Synocure 580 BA 75, Synocure 865 EEP 70, Uracron CY240 EF-75.

By “polyester polyol” we mean any polymer which contains more than one ester functional group. Moreover, the “polyester polyol” contains at least two hydroxyl (OH) functional groups. The functionality of the polyester polyol (i.e. the number of hydroxyl groups present per molecule) may range from 2 to 10.

Preferably, the polyester polyol is one comprising the following repeating unit:

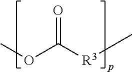

wherein R³ is selected from the group consisting of linear or branched C₁₋₂₀ alkyl groups, C₃₋₁₂ cycloalkyl groups, and optionally substituted C₆₋₂₀ aryl groups; and p is an integer from 2 to 50.

Preferably, R³ is a linear or branched C₁₋₂₀ alkyl group. The term “alkyl” is intended to cover linear or branched alkyl groups such as propyl, butyl, pentyl and hexyl. Particularly preferable alkyl groups are pentyl and hexyl. In all embodiments, the alkyl group is preferably linear. It will be understood that the “alkyl” group in the context of the polyester polyol is divalent and thus may also be referred to as “alkylene”.

In one particularly preferred embodiment, R³ is C₁₋₆alkyl.

Particularly preferred cycloalkyl groups include cyclopentyl and cyclohexyl.

Examples of the substituted aryl groups include aryl groups substituted with at least one substituent selected from halogens, alkyl groups having 1 to 8 carbon atoms, acyl groups, or a nitro group. Particularly preferred aryl groups include substituted and unsubstituted phenyl, benzyl, phenalkyl or naphthyl.

Preferably, p is an integer in the range 2 to 25, such as 2 to 20, e.g. 3 to 15.

The number average molecular weight (Mn) of the polyester polyol is preferably between 200 and 20,000, such as 500 to 10,000, (determined by GPC).

The polyester polyols of the invention preferably have a hydroxyl number of 50-350, such as 100-300, e.g 150-300 mg KOH/g (calculated on non-volatiles).

The viscosity of the polyester polyol at 23° C. may range from 10 mPa·s to 20,000 mPa·s (10 to 20,000 cP), such as 100 mPa·s to 15,000 mPa·s (100 to 15,000 cP), especially 500 mPa·s to 10,000 mPa·s (500 to 10000 cP).

Polyester polyols for use in the invention can be purchased commercially. Commercial suppliers include Arkema, DSM and Nuplex and suitable polyester polyols are sold under trade names such as Setal, Synolac and Uralac. Particular examples of suitable commercially available polyester polyols are Setal 169 SS-67, Synolac 5086 and Uralac SY946.

The at least one hydroxyl containing polymer is preferably present in the coating composition of the invention in a range of 5 to 40 wt %, such as 8 to 30 wt %, e.g. 10 to 20 wt %. It will be appreciated that where more than one hydroxyl containing polymer (i) is present in the coating compositions, the hereinbefore quoted wt % ranges relate to the total amount of all hydroxyl containing polymers employed.

### Polyisocyanate

The coating compositions of the invention also comprise at least one polyisocyanate. The function of the polyisocyanate is as a curing agent.

In the context of the present invention, it is possible to use aliphatic, cycloaliphatic or aromatic polyisocyanates, such as hexamethylene diisocyanate (HDI), trimethylhexamethylene diisocyanate, isophorone diisocyanate, 4,4′-diisocyanatodicyclohexylmethane, tolylene2,4-diisocyanate, o-, m- and p-xylylene diisocyanate, 4,4′-diisocyanatodiphenylmethane; and also, for example, polyisocyanates containing biuret, allophanate, urethane or isocyanurate groups.

Aliphatic polyisocyanates are preferred.

Polyisocyanates based on hexamethylene diisocyanate (HDI) and isophorone diisocyanate (IPDI) are particularly preferred, especially HDI.

The at least one polyisocyanate can be in any form, including but not limited to, dimer, trimer, isocyanurate, adducts, polymeric and prepolymer isocyanate, Polyisocyanate trimers are particularly preferred.

The NCO content of the polyisocyante is preferably 5-25%.

The at least one polyisocyanate is preferably present in the coating composition of the invention in a range of 10 to 45 wt %, such as 12 to 40 wt %, e.g. 15 to 35 wt %. It will be appreciated that where more than one polyisocyanate is present in the coating compositions, the hereinbefore quoted wt % ranges relate to the total amount of all polyisocyanates employed. Where a mixture of two polyisocyanates are present they may be used in a weight ratio of 1:9 to 9:1, preferably 1:4 to 4:1, such as 1:3 to 3:1, e.g. 1:1.

The number average molecular weight (Mn) of the polyisocyanate is preferably between 200 and 3,000 (determined by GPC).

The functionality of the polyisocyanate polymer (i.e. the number of isocyanate groups present per molecule) may range from 2 to 10, e.g. 2 to 5.

In one embodiment, a single polyisocyanate is used in the compositions of invention. In an alternative embodiment, a mixture of two or more polyisocyanates is used.

Polyisocyanates for use in the invention can be purchased commercially. Commercial suppliers include Bayer, BASF, Asahi Kasei and suitable polyisocyanates (iii) are sold under trade names such as Desmodur, Duranate, Tolonate, Basonate. Particular examples of suitable commercially available polycarbonates are Desmodur N3390 and Desmodur N3800.

### Additional Components

The compositions of the invention preferably further comprise a catalyst. Useful catalysts are those well known in the art to facilitate condensation reactions in room temperature curable systems, such as carboxylic salts of tin, zinc, titanium, lead, iron, bismuth, barium and zirconium. Non-metallic catalysts such as tertiary amines, 1,4-diazabicyclo[2.2.2]octane (DABCO) and diazabicycloundecene, may also be employed. A particularly preferred catalyst is dialkyltindilaurate, e.g. dioctyltindilaurate. The amount of catalyst employed may be in the range of 0.01 to 3 wt % of the composition, e.g. 0.02 to 1 wt %, such as 0.04 to 0.08 wt %.

The coating composition of the present invention may also include other substances commonly used in coating formulations such as fillers, pigments, matting agents, solvents and other additives such as waxes, dyes, dispersants, wetting agents, surfactants, light stabiliser, water scavengers and thixotropic agents.

It is preferable if the coating composition of the invention is opaque to visible light, i.e. not clear or not transparent to the naked eye. Thus, in a preferable embodiment, the coating composition comprises at least one pigment. Examples of pigments include organic and inorganic pigments such as titanium dioxide, iron oxides, carbon black, iron blue, phthalocyanine blue, cobalt blue, ultramarine blue, and phthalocyanine green.

Examples of fillers include barium sulphate, calcium sulphate, calcium carbonate, silicas, silicates, bentonites and other clays. The preferred fillers are silica.

Examples of suitable solvents and diluents include aromatic hydrocarbons such as xylene, trimethylbenzene; aliphatic hydrocarbons such as white spirit; ketones such as 2,4-pentanedione, 4-methyl-2-pentanone, 5- methyl-2-hexanone, cyclohexanone; esters such as butyl acetate, 2-methoxy-l-methylethyl acetate and ethyl 3-ethoxypropionate and mixtures thereof.

Solvent preferably makes up 15 to 40 wt % of the composition. Any pigments preferably make up 10 to 30 wt %, e.g. 15 to 25 wt %. Other additives typically total less than 40 wt % of the composition (A +B component =the whole kit). Fillers typically preferably make up 0-40 wt %. When the film is cured there is substantially no longer any solvent in the cured film, i.e. less than 0.5 wt % solvent.

### Composition

In a preferred embodiment, the coating composition of the invention is curable at room temperature, i.e. when the components are mixed the hydroxyl containing components (i) and (ii) and the polyisocyanate (iii) will cure at the temperature in the environment in question without the application of heat. That might typically be in the range of 0 to 50° C. Preferably, curing occurs at less than 40° C., more preferably at room temperature, i.e. in the range 12 to 35° C. It will be understood that since the coating compositions of the invention are curable they may be referred to as curable coating compositions.

The composition is preferably made up of several parts (e.g. two or more parts) to prevent premature curing and hence is shipped as a kit of parts.

The polyol component (i.e. the total amount of polyols, corresponding to components (i) and (ii) together) and the polyisocyanate component are typically present in amounts corresponding to a ratio of equivalents of isocyanate groups to the total number of hydroxyl groups of from 2:1 to 1:2, preferably from 1.5:1 to 1:1.5, such as 1:1.

The weight ratio of the at least one polycarbonate polyol (i) to the at least one hydroxyl containing polymer (ii) is in the range 1:9 to 9:1, preferably 1:4 to 4:1 such as 1:3 to 3:1, e.g. 1:1.

In one embodiment, the volume solids content of the coating composition of the invention is at least 60%.

Alternatively, in other embodiments, the volume solids content of the coating composition is greater than 30%. Preferably, the volume solid content is at least 40%, more preferably at least 50%, such as at least 60%.

In a preferable embodiment, the initial gloss (i.e. prior to exposure) of the coating composition at 60° is less than 50%, preferably less than 45%, such as less than 40%.

The coating composition of the invention may have a volatile organic compound (VOC) content of less than 400 g/L. Preferably the VOC content is less than 350 g/L, more preferably less than 330 g/L.

The viscosity at 23° C. of the coating composition immediately after mixing is preferably less than 1000 mPa s, more preferably less than 600 mPa s, even more preferably less than 500 mPa s, such as less than 400 mPa s.

### Application

The coating compositions of the invention may be utilised to coat a substrate. Suitable substrates include aircraft wings, wind turbine blades, rotor blades, propellers, radomes, antennae, fan blade nose cones and high speed vehicles such as trains or aircraft. Preferably, the substrate is selected from the group consisting of aircraft wings, wind turbine blades, rotor blades, propellers and fan blade nose cones. In a particularly preferred embodiment, the substrate is a wind turbine blade. Typical turbine blades are composed of a material comprising a synthetic resin composite comprising an epoxy resin, a vinyl ester resin, glass or a carbon fiber reinforced resin.

The coating can be applied by any conventional method such as brushing, rolling or spraying (airless or conventional). Preferably, airless spraying is used.

The composition of the present invention is a coating composition and thus, where a substrate is coated with more than one layer, the composition of the invention is preferably applied as the outermost layer. The composition of the invention can be applied onto any pre-treatment layers designed for polyurethane coating layers. In a preferred embodiment, the coating of the invention is applied as part of the following coating system: a laminate layer (e.g. epoxy, vinyl ester), a putty layer (e.g. epoxy or polyurethane), a pore filler layer (e.g. epoxy, polyurethane), an epoxy or polyurethane base coat and a top coat, wherein the coating composition of the invention forms the top coat.

Thus, the invention also relates to a substrate comprising a multilayer paint composition, said substrate comprising the composition of the invention as the outermost layer.

It is preferred if the compositions of the invention are transported in kits, preferably with the polymer components (i) and (ii) kept separate from the polyisocyanate component to prevent curing taking place prior to application to the desired surface. The components should be combined and thoroughly mixed before use. Conventional mixing techniques can be used.

Such kits provide a further aspect of the invention.

The layer formed using the coating composition of the invention preferably has a dry film thickness of 40 to 400 μm, more preferably 80 to 175 μm, such as 100 to 150 μm. It will be appreciated that any layer can be laid down using single or multiple applications of the coating.

The invention will now be described with reference to the following non-limiting examples.

### EXAMPLES

### Determination Methods

### Determination of Viscosity Using Cone and Plate Viscometer

The viscosity of the binders and paint compositions are determined according to ISO 2884-1:2006 using a Cone and Plate viscometer set at a temperature of 23° C. or 40° C. and providing viscosity measurement range of 0-10 P at 10000 s⁻¹.

### Determination of Solids Content of the Compositions

The solids content in the compositions are calculated in accordance with ASTM D5201.

### Determination of Molecular Weight (Mn or Mw)

Molecular weight may be determined by Gel Permeation Chromatography (GPC) or other similar methods known to the skilled worker.

### Calculation of the Volatile Organic Compound (VOC) Content of the Coating Compositions

The volatile organic compound (VOC) content of the coating compositions is calculated in accordance with ASTM D5201.

### Conical Mandrel

A procedure in accordance with ASTM D 522 is used. A 150-250 micron wet film was applied to sanded and degreased steel panel of thickness 0.8 mm, and after curing for 28 days at 23° C. and 50% RH the coated metal panel has been bent around a cylindrical mandrel. The flexibility was regarded as acceptable (test passed) when no cracking was observed.

### Impact

Impact was tested according to ASTM D 2794 using an Erichsen falling weight. The panels were allowed to dry for 7 days at 23° C. and 50% RH before testing. Dry film thickness was measured to 100-160 μm. According to the ASTM D 2794, a coating >140 inch-pounds is considered to be flexible.

### Taber Abrasion

Taber Abrasion tested according to ASTM D 4060-10. A 1 kg weight was applied to the coated steel panel. A CS-10 abrasive wheel was used and 2×500 revolutions employed. The result is presented in terms of the loss of film in mg.

### Drying Time

Drying time was tested using the Beck Koller method in accordance with ASTM D5895. T3 : Surface Hardening Commenced. T4 : Surface hard.

### Artificial Weathering

The UV stability of the coatings is tested by artificial weathering according to ASTM G154. The test cycle has been according to Cycle 1 in the ASTM G154, that is 8h UV exposure at 60° C. using a UVA-340 lamp followed by 4 h condensation at 50° C. The results are given as color difference (deltaE) using a D65 light source and gloss retention (measured gloss*100/initial gloss) after 3000 h.

### Gloss

Gloss was measured according to DIN 67530 at 60° .

### Determination of the Glass Transition Temperature of the Binders by DSC

The glass transition temperature (Tg) of the binders is obtained by Differential Scanning calorimetry (DSC) measurements. The DSC measurements were performed on a TA Instruments DSC Q200. Samples were prepared by transferring a small amount of polymer solution to an aluminium pan The samples of approx. 10 mg polymer material were measured in open aluminum pans and scans were recorded at a heating and cooling rate of 10° C./min with an empty pan as reference. The inflection point of the glass transition range, as defined in ASTM E1356-08, of the second heating is reported as the Tg of the polymers.

### Determination of the Glass Transition Temperature of the Cured Coating Films by DMA

Glass transition temperature (Tg) of the cured paint films was determined by

Dynamic Mechanical Analyser (DMA) with a TA Instruments, Q800 using tension-film clamp. The coatings were cured for at least 4 weeks at 23° C. before testing. The amplitude is chosen to be within the linear Viscoelastic Region by using a the Force ramp test, Mode static force. For the Tg and also storage modulus assessment the mode Multi-Frequency Strain was used with a temperature range of −50-200° C. heating at a ramp of 4° C./min. under N2 environment.

Other parameters of use are: Amplitude of 20 μm and a preload force of 0.02N.

Tg is assigned as the peak in the Tan δ vs Temperature plot. The reported Storage Modulus value is assigned at 23° C.

### Rain Erosion Test

Rain erosion testing is carried out using a whirling arm rig which is designed for the purpose by Polytech A/S. The rotor has the following specifications: max radius 915 mm, max circumference 2875 mm, max speed of rotation 1670 rpm, sample tip speed up to 160 m/s.

The test is made to simulate the rain erosion created on blades by heavy rainfall. 22.5 cm long test subjects simulating the leading edge of a wind turbine blade of fiber reinforced plastic (radius of curvature: 8-9 mm) are coated with 100-150 μm (dry film thickness) of the coating compositions to be tested. The coating compositions are cured either 23° C. for 2 weeks or at 50° C. (accelerated conditions) for two days to secure complete cure of the polyurethane binder. Three test subjects are then mounted on a horizontal rotor with three blades. The rotor is spun at a controlled velocity resulting in a test subject velocity ranging from 123 m/s closest to the rotor axis to 157 m/s farthest away from the rotor axis. During the test water drops of controlled diameter (1-2 mm) are sprayed evenly over the rotor and onto the coating surface at a controlled and constant rate (30-35 mrn/h).

Every 30 minutes the rotor is stopped and the coating surface on the leading edge of the test subject is visually examined for defects.

In order for the topcoat to pass the test it should have minimal or no visual damages on the leading edge of the test subject at a velocity of 140 m/s or slower after being exposed for 3 hours. This is a typical acceptance criterion used by the industry. High performance coatings have no visible damages to the coating on the leading edge of the test subject at 140 m/s and slower after 3 hours exposure. (140 m/s equals the “length of damaged area” of 11.5 cm. The velocity given in the test schemes is the lowest velocity where no visible damage is present after 3 h of exposure.

### General Procedure for Preparation of the Compositions

Component A was made by mixing all the indicated ingredients in a dissolver in a conventional manner known to the person skilled in the art. Component A was then subsequently mixed with Component B/Curing agent prior to application.

The compositions of the inventive coating compositions are presented in Table 1. Comparative examples are set out in Table 2. The properties of the various compositions are set out in Table 3 and 4.

TABLE 1
Examples. Compositions by weight

| | | | | | | | | |
|---|---|---|---|---|---|---|---|---|
| 1 | 2 | 3 | 4 | 5 | 6 | 7 | 8 | 9 |

Component A

| | | | | | | | | | |
|---|---|---|---|---|---|---|---|---|---|
| Acrylic polyol 1 | 12.9 | 13.7 | 13.0 | 12.3 | | | 6.4 | 19.5 | |
| Polycarbonate 1 | 12.9 | 13.7 | | | 11.2 | 12.4 | 19.2 | 6.5 | 16.9 |
| Polycarbonate 2 | | | 13.0 | | | | | | |
| Polycarbonate 3 | | | | 12.3 | | | | | |
| Polyester polyol 1 | | | | | 11.2 | 12.4 | | | |
| Polyester polyol 2 | | | | | | | | | 5.7 |
| Solvents | 21.2 | 22.5 | 21.3 | 20.3 | 18.3 | 20.3 | 21.0 | 21.4 | 21.2 |
| Additives* | 6.8 | 7.2 | 6.8 | 6.5 | 5.9 | 6.5 | 6.7 | 6.8 | 6.6 |
| TiO2 | 20.1 | 21.4 | 20.3 | 19.3 | 17.4 | 19.3 | 20.0 | 20.3 | 18.8 |
| Matting agent | 6.7 | 7.1 | 6.7 | 6.4 | 5.8 | 6.4 | 6.6 | 6.7 | 6.0 |
| Dioctyltin dilaurate | 0.04 | 0.04 | 0.04 | 0.04 | 0.04 | 0.04 | 0.04 | 0.04 | 0.1 |

Component B

| | | | | | | | | | |
|---|---|---|---|---|---|---|---|---|---|
| Polyisocyanate 1** | | 6.5 | | | | 11.3 | | | |
| Polyisocyanate 2 | 19.4 | 7.9 | 18.9 | 22.9 | 30.3 | 11.3 | 20.1 | 18.8 | 24.7 |
| SUM | 100 | 100 | 100 | 100 | 100 | 100 | 100 | 100 | 100 |
| PVC [%] | 22 | 20 | 23 | 21 | 17 | 20 | 21 | 24 | 15 |
| Volume Solids [%] | 65 | 66 | 65 | 67 | 74 | 70 | 68 | 63 | 70 |
| VOC [g/l] | 312 | 302 | 319 | 301 | 232 | 272 | 288 | 336 | 275 |

*Dispersants, moisture scavenger, air release agent, thixotropic agent, light stabilizer
**90 wt % solid solution in butyl acetate
PVC = Pigment Volume concentration

Acrylic polyol 1, viscosity (23° C.) 4500-9000 cP (as 75 wt % solution in butyl acetate), hydroxyl content on non-volatiles 4.1%
Acrylic polyol 2, viscosity (23° C.) 2000-3600 cP (as 75 wt % solution in butyl acetate), hydroxyl content on non-volatiles 5.0%
Acrylic polyol 3, viscosity (23° C.) 4000-7000 cP (as 75 wt % solution in butyl acetate), hydroxyl content on non-volatiles 4.5%
Polycarbonate 1, viscosity (40° C.) 2800 cP, hydroxyl content on non-volatiles 3.3%
Polycarbonate 2 , viscosity (40° C.) 1000 cP, hydroxyl content on non-volatiles 3.3%
Polycarbonate 3, viscosity (40° C.) 1100 cP, hydroxyl content on non-volatiles 5.2%
Polyester polyol 1, viscosity (23° C.) 750-1000 cP, hydroxyl content on non-volatiles 7.4%
Polyester polyol 2, viscosity (23° C.) 4000-7000 cP, hydroxyl content on non-volatiles 8.6%
Polyisocyante 1, HDI trimer with viscosity (as 90 wt % solution) (23° C.) 550 cP
Polyisocyante 2, HDI trimer with viscosity (23° C.) 6000 cP

TABLE 2
Comparable examples. Composition by weight

| | | | | |
|---|---|---|---|---|
| C1 | C2 | C3 | C4 | C5 |

Component A

| | | | | | |
|---|---|---|---|---|---|
| Acrylic polyol 1 | | | | 26.2 | |
| Acrylic polyol 2 | 20.8 | | | | |
| Acrylic Polyol 3 | | 21.2 | 20.1 | | |
| Polycarbonate 1 | | | | | 25.4 |
| Polyethylene glycol 400 | 6.9 | 7.1 | 6.7 | | |
| Solvents | 16.2 | 16.5 | 15.7 | 21.5 | 20.9 |
| Additives* | 4.2 | 4.3 | 4.1 | 6.9 | 6.7 |
| TiO2 | 16.2 | 16.5 | 15.7 | 20.5 | 19.8 |
| Talc | 3.7 | 3.8 | 3.6 | | |
| Matting agent | 5.5 | 5.6 | 5.3 | 6.8 | 6.5 |
| Dioctyltin dilaurate | 0.04 | 0.04 | 0.04 | 0.04 | 0.04 |

Component B

| | | | | | |
|---|---|---|---|---|---|
| Polyisocyanate 1** | 17.8 | 16.8 | 9.5 | | |
| Polyisocyanate 2 | 8.7 | 8.3 | 19.3 | 18.1 | 20.7 |
| SUM | 100 | 100 | 100 | 100 | 100 |
| PVC [%] | 22 | 23 | 20 | 25 | 30 |
| Volume Solids [%] | 66 | 66 | 69 | 60 | 62 |
| VOC [g/l] | 299 | 303 | 277 | 362 | 343 |

*Dispersants, moisture scavenger, air release agent, thixotropic agent, light stabilizer
**90 wt % solid solution in butyl acetate
PVC = Pigment Volume concentration

TABLE 3
Test results. Examples of the invention

| | | Formulation | | | | | | | | |
|---|---|---|---|---|---|---|---|---|---|---|
| | | 1 | 2 | 3 | 4 | 5 | 6 | 7 | 8 | 9 |
| Taber Abraser [mg] | | 72 | 74 | 125 | 85 | 129 | 215 | 194 | 80 | 163 |
| Rain Erosion Test [m/s] | | 140 | 136 | 142 | 142 | 150 | 136 | 137 | 138 | >157 |
| Viscosity at 23° C. [cP] | | 405 | 405 | 450 | 580 | 825 | 495 | 657 | 314 | 702 |
| Conical | Pass/fail | Pass | Pass | Pass | Pass | Pass | Pass | Pass | Pass | Pass |
| Mandrel | | | | | | | | | | |
| Impact | [Inch-pounds] | 160 | 160 | 160 | 160 | 160 | 160 | 160 | 160 | 160 |
| DMA | Tg [° C.] | −6 | | −14 | −9 | −30 | −24 | −20 | 11 | −20 |
| | Storage | 39 | | | | | | 18 | 89 | |
| | Modulus | | | | | | | | | |
| | [MPa] | | | | | | | | | |
| Drying time | T3 [hh:mm] | 03:35 | 02:30 | 05:00 | 05:00 | 06:45 | 06:00 | 05:00 | 03:30 | 09:00 |
| B&K | T4 [hh:mm] | 05:30 | 04:00 | 06:30 | 09:00 | 10:45 | 09:30 | 09:00 | 04:30 | 10:30 |
| QUV-A | DeltaE | 0.22 | | 0.21 | 0.3 | | | | | 0.6 |
| Exposure | Initial gloss | 11 | 8 | 9 | 15 | 55 | 24 | 18 | 14 | 19 |
| | [%] | | | | | | | | | |
| | Gloss | 92 | 100 | 96 | 79 | 49 | 71 | 65 | 91 | 80 |
| | retention [%] | | | | | | | | | |

TABLE 4
Test results. Comparable examples

| | | Formulation | | | | |
|---|---|---|---|---|---|---|
| | | C1 | C2 | C3 | C4 | C5 |
| Taber Abraser [mg] | | 30 | 45 | 32 | 64 | 369 |
| Rain Erosion Test [m/s] | | <123 | — | <123 | 125 | — |
| Viscosity at 23° C. [cP] | | 287 | 325 | 418 | 214 | 788 |
| Conical | Pass/fail | Pass | Pass | Pass | Pass | Pass |
| Mandrel | | | | | | |
| Impact | [Inch-pounds] | — | 160 | 160 | 160 | 160 |
| DMA | Tg [° C.] | | 13 | | 35 | −30 |
| | Storage | | | | 1162 | 0.4 |
| | Modulus | | | | | |
| | [MPa] | | | | | |
| Drying time | T3 [hh:mm] | 01:00 | 02:00 | 01:50 | 09:00 | 01:30 |
| B&K | T4 [hh:mm] | 06:00 | 08:30 | 08.00 | >12:00 | 04:10 |
| QUV-A | DeltaE | | | | | |
| Exposure | Initial gloss | 30 | 26 | 25 | 14 | 11 |
| | [%] | | | | | |
| | Gloss | | | | 98 | 99 |
| | retention [%] | | | | | |

*QUV-A 3000 hours

1. A substrate coated with a coating composition, wherein the coating composition has a volume solids content of greater than 30%, said composition comprising:
(i) at least one polycarbonate polyol;
(ii) at least one hydroxyl containing polymer selected from the group consisting of an acrylic polyol, a polyester polyol and a mixture thereof; and
(iii) at least one polyisocyanate curing agent;
wherein the weight ratio of (i):(ii) is 9:1 to 1:9 and wherein, if present, said polyester polyol is different to said poly⁻carbonate polyol; and
wherein the substrate is selected from the group consisting of aircraft wings, wind turbine blades, rotor blades, propellers, randomes, antenaae, fan blade nose cones and high speed vehicles.

2. A substrate as claimed in claim 1, wherein the substrate is selected from the group consisting of aircraft wings, wind turbine blades, rotor blades, propellers and fan blade nose cones.

3. A substrate as claimed in claim 1, wherein said at least one polycarbonate polyol comprises at least one repeating unit with the following structure: 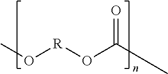
wherein
R is selected from the group consisting of linear or branched C₁₋₂₀ alk groups, C₃₋₁₂ cycloalkyl groups, and optionally substituted C₆₋₂₀ aryl groups; and
n is an integer from 2 to 50.

4. A substrate as claimed in claim 1, wherein said acrylic polyol has a viscosity in the range from 10 mPa·s to 20,000 mPa·s (10 to 20,000 cP), when measured at 23° C.

5. A substrate as claimed in claim 1, wherein said polyester polyol has a viscosity in the range 10 mPa·s to 20,000 mPa·s (10 to 20,000 cP), when measured at 23° C.

6. A substrate as claimed in claim 1, wherein said at least one polyisocyanate is an aliphatic polyisocyanate, preferably a polyisocyanate.

7. A substrate as claimed in claim 1, wherein the at least one hydroxyl containing polymer (ii) is an acrylic polyol.

8. A substrate as claimed in claim 7, wherein the acrylic polyol comprises the following repeating unit: 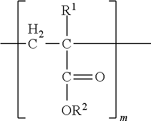
wherein R¹ and R² may be the same or different, and are each independently selected from the group consisting of hydrogen, linear or branched C₁₋₂₀ alkyl groups, linear or branched hydroxyC₁₋₂₀alkyl groups, C₃₋₁₂ cycloalkyl groups, and optionally substituted C₆₋₂₀ aryl groups; and
in is an integer from 2 to 50.

9. A substrate as claimed in claim 1, wherein the at least one hydroxyl containing polymer (ii) is a polyester polyol.

10. A substrate as claimed in claim 9, wherein the polyester polyol comprises the following repeating unit: 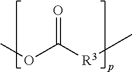
wherein R³ is selected from the group consisting of linear or branched C₁₋₂₀alkyl groups, C₃₋₁₂ cycloalkyl groups, and optionally substituted C₆₋₂₀ aryl groups; and
p is an integer from 2 to 50.

11. A substrate as claimed in claim 1, wherein the volume solid content of the coating composition is at least 40%.

12. (canceled)

13. A process for coating a substrate with a coating composition, said process comprising applying said composition to the surface of said substrate, wherein said coating composition has a volume solids content of greater than 30%, said composition comprising:
(i) at least one polycarbonate polyol;
(ii) at least one hydroxyl containing polymer selected from the group consisting of an acrylic polyol a polyester polyol and a mixture thereof and
(iii) at least one polvisocvanate curing agent:
wherein the weight ratio of (i):(ii) is 9:1 to 1:9 and wherein, if present, said polyester polyol is different to said polycarbonate polyol: and
wherein the substrate is selected from the group consisting of aircraft wings, wind turbine blades, rotor blades, propellers_{;} randomes, antenaae, fan blade nose cones and high speed vehicles.

14. A process as claimed in claim 13, further comprising curing said composition at a temperature of less than 50° C.

15. A coating composition having volume solids content of greater than 60%, said composition comprising:
(i) at least one polycarbonate polyol;
(ii) at least one hydroxyl containing polymer selected from the group consisting of an acrylic polyol, a polyester polyol and a mixture thereof; and
(iii) at least one polyisocyanate curing agent;
wherein the weight ratio of (i):(ii) is 9:1 to 1:9 and wherein, if present, said polyester polyol is different to said polycarbonate polyol.

16. (canceled)

17. A kit for use in the manufacture of a coating composition as defined in claim 15, said kit comprising:
a) at least one polycarbonate polyol and at least one hydroxyl containing polymer selected from the group consisting of an acrylic polyol, a polyester polyol and a mixture thereof in a first part; and
b) at least one polyisocyanate curing agent in a second part.

18. A substrate as claimed in claim 1, wherein the substrate is a wind turbine blade.

19. A substrate as claimed in claim 1, wherein said at least one polyisocyanate is based on hexatnethylene diisocyanate (HDI) or isophorone diisocyanate (IPDI).

20. The coating composition as claimed in claim 15, wherein said at least one polycarbonate polyol comprises at least one repeating unit with the following structure: 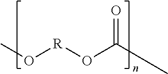
wherein
R is selected from the group consisting of linear or branched C₁₋₂₀ alkyl groups, C₃₋₁₂ cycloalkyl groups, and optionally substituted C₆₋₂₀ aryl groups; and
n is an integer from 2 to 50.

21. The coating composition as claimed in claim 15, wherein said at least one polyisocyanate is an aliphatic polyisocyanate.

22. The coating composition as claimed in claim 21, wherein said at least one polyisocyanate is based on hexamethylene diisocyanate (HDI) or isophorone diisocyanate (IPDI).

23. The coating composition as claimed in claim 15, wherein the at least one hydroxyl containing polymer (ii) is an acrylic polyol.

24. The coating composition as claimed in claim 23, wherein the acrylic polyol comprises the following repeating unit: 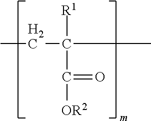
wherein R¹ and R² may be the same or different, and are each independently selected from the group consisting of hydrogen, linear or branched C₁₋₂₀ alkyl groups, linear or branched hydroxyC₁₋₂₀alkyl groups, C₃₋₁₂ cycloalkyl groups, and optionally substituted C₆₋₂₀ aryl groups; and
m is an integer from 2 to 50.

25. The coating composition as claimed in claim 15, wherein the at least one hydroxyl containing polymer (ii) is a polyester polyol.

26. The coating composition as claimed in claim 25, wherein the polyester polyol comprises the following repeating unit: 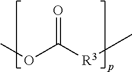
wherein R³ is selected from the group consisting of linear or branched C₁₋₂₀alkyl groups, C₃₋₁₂ cycloalkyl groups, and optionally substituted C₆₋₂₀ aryl groups; and
p is an integer from 2 to 50.

27. The coating composition as claimed in claim 15, wherein the weight ratio of the at least one polycarbonate polyol (i) to the at least one hydroxyl containing polymer (ii) is in the range 1:4 to 4:1.
